(19) United States
(12) Patent Application Publication
(10) Pub. No.: US 2015/0284935 A1
(43) Pub. Date: Oct. 8, 2015

(54) METHOD AND DEVICE FOR DETECTING THE PRESENCE OF STONE CRUSHING TOOLS ON EARTHMOVING MACHINES

(71) Applicant: IDENTEC SOLUTIONS AG, LUSTENAU (AT)

(72) Inventors: Daniel Egger, Satteins (AT); Brian Robertson, Horgen (CH)

(21) Appl. No.: 14/420,927

(22) PCT Filed: Aug. 3, 2013
(86) PCT No.: PCT/EP2013/002333

§ 371 Date: Jun. 10, 2015

(30) Foreign Application Priority Data
Aug. 11, 2012 (DE) 102012016004.6

(51) Int. Cl. E02F 9/26; G07C 5/08; E02F 9/28

(52) U.S. Cl. CPC E02F 9/267; E02F 9/2808; G07C 5/0816

(57) ABSTRACT

The invention relates to a method for detecting the presence of stone crushing tools on earthmoving machines, wherein at least one RFID tag (5) is arranged in the tool (3, 4) executing an at least periodic radio communication (7) with a reader (11). The interruption and/or absence thereof generates an alarm signal as an indication of a non-functioning or broken-off tool.

The invention relates to a method and a device for detecting the presence of tools on earthmoving machines according to the preamble of patent claim 1.

The term “earthmoving machine” is understood to refer to a variety of machines that have stone crushing, earthmoving and boulder moving tools.

This term is understood to include mainly dredging shovels, shovel dredgers, cable dredgers or bulldozers, which always carry shovels or other dozing tools equipped with teeth as tools.

The term “earthmoving machine” is also understood to include underground mining machines such as coal cutting machines or tunnel drilling machines or the like.

With such machines that are intended for moving rocks, boulders and pebbles or for crushing boulders and/or pebbles from rock masses, there is the problem that the crushing tools used for this purpose, in particular the teeth, are replaceable and are subject to great wear.

It may therefore happen during such work that such a tooth breaks out of its mount or the mount itself breaks off, which is associated with the disadvantage that the tooth, which is usually made of metal, is removed along with the rock that has been cut. However, this leads to the disadvantage that, when the rock that has been removed is sent to a rock cutting or crushing machine, the tooth from the tool that has been entrained with the rock enters the cutting or crushing mechanism of the machine, where it can cause serious damage to the breaking or crushing tools.

Based on the use of a dredger, from whose excavator shovel a tooth has been broken off, this problem has been solved in the past only through visual observation of the crushed material. It is known that the dredger conveys the crushed material onto a front-end loader, and the front-end loader itself brings the loaded material directly into a crusher. In particular with such an operation it is practically impossible to track a tooth that has been broken off from a dredger and to discover it.

The object of the invention is therefore to monitor the presence of tools that have been broken off from earthmoving machines of the type defined in the introduction, so that a nonfunctioning tool or even loss of a tool from such an earthmoving machine can be discovered by using simple means.

To solve the problem as formulated, the invention is characterized by the technical teaching of claim 1.

The main feature of the invention is that at least one RFID tag, which maintains at least periodic radio communication with a reader, is provided in the earthmoving tool, for example, the dredger tooth. The reader then monitors and detects the ongoing presence of the RFID-monitored tool on the working device.

The given technical teaching yields the important advantage that wireless monitoring of the tools used by the earthmoving machine is accomplished by the fact that the tools are each individually connected to an RFID tag. The RFID tag is thus connected to the tool to be monitored. A simple connection is derived from the fact that the RFID tag is installed in a suitable cavity in the tool to be monitored and therefore is protected from the rock masses that are broken off. It should also be installed in this tool in a protected manner outside of the working area of the tool.

For example, if a dredger has a number of 15 dredger teeth on its shovel, for example, then it is provided in a preferred embodiment that each tooth carries an individual RFID tag or this RFID tag is installed in the tooth and it is even possible to ascertain, by means of this individual identifier of the RFID tag, which tooth has been broken off of the dredger and removed with the crushed rock.

In another embodiment of the invention, it is provided that not only are the earthmoving tools monitored but also the other function parts of the earthmoving apparatus of the earthmoving machine, in particular the side wall of the dredging shovel or other function parts that belong to the earthmoving tool, are also monitored.

In the latter case, the side wall, for example, is also designed to be replaceable. Therefore, an RFID tag is also provided on each of the right and left side walls.

It is important with this invention that the monitoring for the presence or removal of the dredger tooth is performed on the earthmoving machine itself, i.e., a reader is provided on the earthmoving machine to maintain wireless communication with the RFID tag in the earthmoving tool by means of one or more suitable antennas.

It is thus possible to display immediately in the working cab of the earthmoving machine when an earthmoving tool or a part of an earthmoving tool, such as the side wall of the dredging shovel, the dredging tooth or other function parts, for example, have been damaged or removed.

The invention is not limited to the fact that the presence or functionality of the earthmoving tool itself is checked such as, for example, the dredger tooth or the side wall of the earthmoving tool, but in addition, the functionality of the adapter plate, which serves to establish a mechanical connection between the dredger tooth and the earthmoving shovel, is checked.

Even if the adapter plate is damaged in that, for example, the dredger tooth has caused a break in the adapter plate, this is also detected by the RFID tag in the dredger tooth and reported to the earthmoving vehicle. In another embodiment, the adapter plate may also have its own RFID tag, which reports a break in the mount of the dredger tooth or any other damage to the mount.

The invention is not limited to the fact that the reader is installed in the earthmoving vehicle itself. It may also be located in a remote central office, in particular when remote-controlled tools are being used so there is no longer any monitoring at all in the earthmoving vehicle itself. Thus this is an unmanned earthmoving machine that is only monitored in a central office.

Likewise, in another embodiment of the invention, it is provided that, although the display for indicating the lack of functionality of one of the earthmoving tools is located in the cab of the earthmoving machine, but wireless communication with a remote stationary central office where there is an additional display is provided.

Such wireless communication may take place by means of a WLAN antenna from the earthmoving vehicle to a central office located at a distance.

According to another important feature, the invention lies in the fact that the RFID-monitored dredger tooth or the RFID-monitored earthmoving tool is additionally connected to an acceleration sensor. This acceleration sensor is electrically connected to the RFID tag, so that the measured values detected by the acceleration sensor are transmitted by wireless communication between the RFID tag with the reader and monitored there. The feature of providing an acceleration sensor in the monitored tool should be protected, either alone or in combination with the arrangement of an RFID tag.

With the arrangement of at least one acceleration sensor in an earthmoving tool, for example, a dredger tool, a side wall of an angle dozer or the like, the important advantage that now the operation of the dredger tooth which is still functional or the earthmoving tool can be detected. By including the acceleration cycles and recording them, the number of acceleration cycles can be ascertained in order to ensure that, for example, after a certain number of acceleration cycles of 5000 or 10,000, for example, it is possible to conclude that the earthmoving tool, for example, the dredger tooth must be replaced. Information about wear can thus be obtained on the basis of the type of acceleration cycles.

Altered acceleration values may indicate a damaged mount or a broken tooth, for example, even if the tooth has not been removed from the mount and disappeared with the crushed material.

According to another feature of the invention it is now also possible to detect when a dredger tooth has broken off, even if the tooth is still within the wireless range of the reader. In this case the reader would still maintain the wireless communication with the broken off dredger tooth but the acceleration sensor will show a zero acceleration, even during the working time of the earthmoving vehicle, so that it is possible to make a statement that the earthmoving tool is now nonfunctioning and a corresponding alarm message is sent to the central office or to the display in the earthmoving vehicle. This permits early warning.

The invention thus goes beyond mere RFID monitoring of an earthmoving machine in that it is additionally provided that at least one acceleration sensor is installed in at least one part of the earthmoving tool to thereby be able to detect whether it is nonfunctioning. This was impossible when using simple RFID presence monitoring.

The subject matter of the present invention is derived not only from the subject matter of the individual patent claims but also from the combination of the individual patent claims with one another.

All the information and features disclosed in the documents, including the abstract, in particular the spatial design shown in the drawings, are herewith claimed as essential to the invention inasmuch as they are novel both individually and in combination in comparison with the prior art.

The invention is explained in greater detail below on the basis of drawings illustrating just one possible embodiment. Additional features and advantages of the invention that are essential to the invention are derived here from the drawings and the description thereof.

They show:

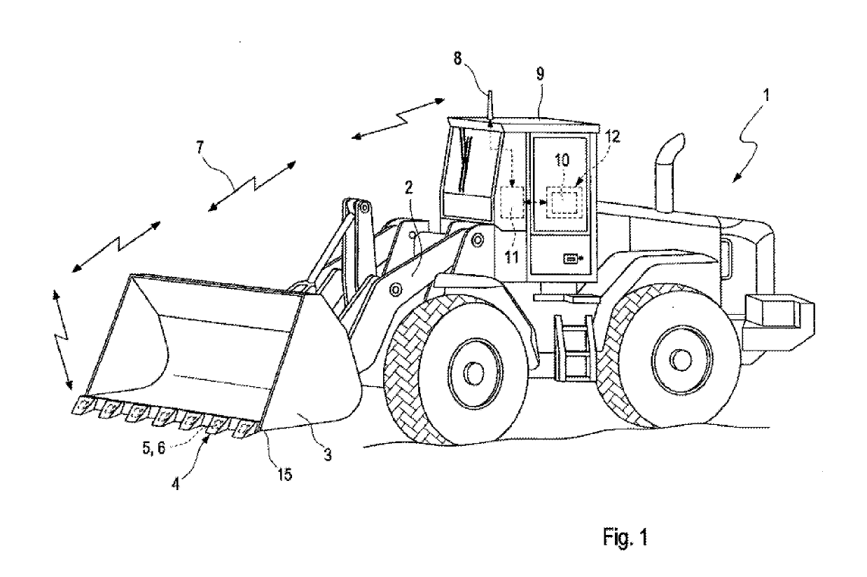

FIG. 1 an earthmoving machine schematically in the form of a shovel dredger

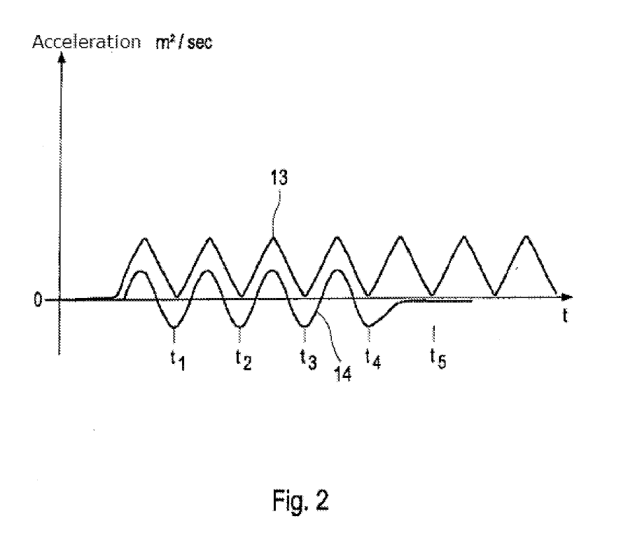

FIG. 2 an acceleration-time diagram

FIG. 1 shows in general an earthmoving machine 1 in the form of a shovel dredger consisting essentially of a cab 9 and a running gear on which a dredger arm 2 is mounted pivotably, a shovel 3 having a number of dredger teeth 4 being installed on its free front end.

An RFID tag 5 is preferably provided in each of the dredger teeth. The dredger tooth 4 is connected to the shovel 3 by means of an adapter plate 15. A permanent battery power supply is provided in each RFID tag 5, so that no additional lines from the dredger arm to the shovel 3 are necessary. The adapter plate 15 serves to provide a mechanical connection between the dredger tooth 4 and the adapter plate 15 which is provided on the shovel 3.

Each dredger tooth 4 maintains wireless communication 7 with an antenna 8 on the dredger by means of the installed RFID tag 5. This antenna is part of a reader 11 provided in the interior of the cab 9 and working together with a PC 12 and a display 10.

As soon as a dredger tooth 4 is broken out of the adapter plate 15 and the wireless communication 7 with the reader 11 is interrupted, an alarm message appears on the display 10.

Now, however, it may happen that the dredger tooth 4 is still signed onto the reader 11 with its wireless communication 7, despite the fact that the dredger tooth itself is no longer functional. In such a case, the additional feature of the present invention provides a remedy, so that an acceleration sensor 6 is also provided in the dredger tooth 4 in addition to the RFID tag 5. The acceleration sensor may be connected directly to the RFID tag or may be installed with it in a shared housing.

The functioning of a dredger tooth 4 can be monitored by means of the acceleration diagram recorded by the acceleration sensor 6 and sent by wireless communication 7 to the PC 12.

This is apparent from the diagram according to FIG. 2.

FIG. 2 shows two acceleration diagrams 13 and 14 for two different dredger teeth. These correspond in their acceleration peaks and deceleration peaks because normal operation of the earthmoving machine using the shovel 3 involves periodic movements of the earth, so that there are cyclic processing operations t₁, t₂, t₃ and t₄, starting from the resting time t0.

The number of cycles, as defined by the intervals of times t₁-t₄, are counted. At the end of a certain number of cycles, for example, 5000 or 10,000 cycles, a message is output indicating that the dredger tooth must be replaced because of wear.

If the dredger tooth 2 is broken out at the point in time t₄, which leads to a loss of acceleration at point in time t₅ in the diagram 14, this is a clear-cut indication that the dredger tooth 4 that has been broken off is no longer attached to the shovel 3 and is no longer participating in the processing operation.

In another preferred embodiment of the invention, in addition to the acceleration sensor, an additional temperature sensor is provided in the dredger tooth or in the other earthmoving tool, also relaying its temperature values to the reader by means of wireless communication 7 and monitoring the temperature.

### LEGEND TO THE DRAWINGS

1 Earthmoving machine
2 Types of dredgers
3 Shovel
4 Dredger tooth
5 RFID tag
6 Acceleration sensor
7 Wireless communication
8 Antenna
9 Cab
10 Display
11 Reader
12 PC
13 Diagram of tooth 1
14 Diagram of tooth 2
15 Adapter plate

1. A method for detecting the presence of stone crushing tools on earthmoving machines, comprising: providing at least one RFID tag (5), which has at least periodic wireless communication (7) with a reader (11), in the tool (3, 4), and generating an alarm message when said at least periodic wireless communication is interrupted and/or stopped.

2. The method according to claim 1, wherein the RFID tag is installed in the adapter plate (15) for mounting the tool (3, 4).

3. The method according to claim 1, wherein the reader (11) is installed in the earthmoving machine (1).

4. The method according to claim 1, further comprising providing an acceleration sensor (6) in or on the tool (3, 4), analyzing acceleration values of the tool, and transmitting the acceleration values from the acceleration sensor (6) to the reader (11) by wireless communication with the RFID tag (5).

5. The method according to claim 4 further comprising detecting a number of working cycles with the analysis of the acceleration values of the acceleration sensor (6).

6. The method according to claim 4, further comprising detecting the presence of the tool on the earthmoving machine (1) with the analysis of the acceleration values of the acceleration sensor (6).

7. The method according to claim 4, further comprising detecting functionality of the tool on the earthmoving machine (1) with the analysis of the acceleration values of the acceleration sensor (6).

8. A device for detecting the presence of stone crushing tools on earthmoving machines for detecting the function and/or presence of stone crushing tools on earthmoving machines, comprising at least one RFID tag (5), which performs at least periodic wireless communication (7) with a reader (11) installed in the tool (3, 4), and an acceleration sensor (6) is installed in or on the tool (3, 4), and transmitting acceleration values to the reader (11) by wireless communication with the RFID tag (5).

9. A device for detecting the presence of stone crushing tools on earthmoving machines for detecting the function and/or presence of stone crushing tools on earthmoving machines, comprising at least one RFID tag (5) installed in the tool (3, 4) to perform at least periodic wireless communication (7) with a reader (11).

10. A device for carrying out the method according to claim 1, the device comprising at least one RFID tag (5) installed in the tool (3, 4) to perform at least periodic wireless communication (7) with a reader (11), and optionally, an acceleration sensor (6) installed in or on the tool (3, 4), and transmitting acceleration values to the reader (11) by wireless communication with the RFID tag (5), wherein the reader (11) is installed in or on the earthmoving machine (1), and at least one PC (12) and display (10) for output of the alarm message are installed in the cab (9) of the earthmoving machine (1).

11. The method according to claim 2, wherein the RFID tag is installed in the adapter plate (15) for mounting the tool (3, 4).
